(19) United States
(12) Patent Application Publication
(10) Pub. No.: US 2015/0143971 A1
(43) Pub. Date: May 28, 2015

(54) Bread-Knife Blade and a Method for Its Manufacture

(71) Applicant: AB MUNKFORSSAGAR, Munkfors (SE)

(72) Inventor: Per-Olov Hallberg, Munkfors (SE)

(73) Assignee: AB MUNKFORSSAGAR, Munkfors (SE)

(21) Appl. No.: 14/409,174

(22) PCT Filed: Jun. 24, 2013
(86) PCT No.: PCT/SE2013/050759

§ 371 Date: Dec. 18, 2014

(30) Foreign Application Priority Data
Jun. 29, 2012 (SE) 1250739-8

(51) Int. Cl. B24B 3/58; B26D 1/00

(52) U.S. Cl. CPC B24B 3/586; B26D 1/0006; B26D 2001/0053; B26D 2001/006
USPC 83/854; 451/45

(57) ABSTRACT

The present invention relates to a bread-knife blade for machine saws, which bread-knife blade (1) blade has teeth (2) with a tooth edge (E), a tooth breast (H) at the front of the tooth, seen in the sawing directing, a tooth back (F) behind the tooth edge (E), and a tooth bottom (B) between the tooth breast of each tooth and the tooth back of next tooth in front thereof, and tooth gaps, wherein a tooth gap (G) is defined as the space between the tooth edges (E) of two subsequent teeth (2), which knife blade has two flat sides (L, R), a right side (R) and a left side (L), when the knife blade is regarded obliquely from above in the sawing directing, wherein said tooth edge (E) consists of a point.

### TECHNICAL FIELD

The present invention relates to a bread-knife blade for machine saws, which bread-knife blade has teeth with a tooth edge, a tooth breast at the front of the tooth, seen in the sawing directing, a tooth back behind the tooth edge, and a tooth bottom between the tooth breast on each tooth and the tooth back of the next tooth in front thereof, and tooth gaps, wherein a tooth gap is defined as the space between the tooth edges of two subsequent teeth, which knife edge has two flat sides, a right side and a left side, when the knife blade is regarded obliquely from above in the sawing directing, wherein said tooth edge consists of a point. The invention also relates to a method for the manufacture of a bread-knife blade.

### BACKGROUND

Bread-knife blades for machine saws for industrial use have been a more and more important product as more and more consumers choose to buy ready-sliced bread. The machine equipment used is in principle similar to a traditional machine saw, but in contrast to sawing a bread-knife blade shall preferably not use anything of the bread when it works through it. Moreover, high environmental and hygienic requirements are often made in environments where bread-knife blades for machine saws are used.

FIGS. 1 and 2 of the invention show two different bread-knife blades presently known which have been widely acclaimed on the market, partly as they cut in principle entirely without cutting waste, partly as they also contribute to a positive environmental effect in other aspects. A disadvantage of this known type of bread-knife blades is that they are expensive to manufacture, depending on the fact that a complex grinding technique must be used at the manufacture. Through EP 1 030 763 another type of bread-knife blade is known, which also is available on the market, which also requires a complex manufacture implying high costs.

### DISCLOSURE OF THE INVENTION

The purpose of the present invention is to offer a bread-knife blade having the same kind of basic functionality as known blades but which may be manufactured at a lower cost which is achieved with a bread-knife blade according to claim 1.

Thanks to a construction according to the invention a bread-knife blade may be manufactured at a substantially lower cost than bread-knife blades known on the market. Further, tests have shown that a bread-knife blade according to the invention implies surprising improvements, partly of the working environment as it results in drastically reduced sound levels during use as compared to known bread-knife blades, partly as to function as it gives a better cutting surface and less waste than known blades, and in addition it has a longer lifetime than known blades.

According to additional aspects of the invention it applies that;
the inclination of the tooth breast and the tooth back, respectively, is asymmetric and that the tooth back inclines essentially steeper downwards than the tooth breast;
said tooth breast has an angle in relation to the longitudinal direction of the blade in the range 20°-49°, preferably 25°-35°;
the angle between a transverse line and a line between the tooth edge and the central point of the tooth back is in the range −20° to 20°, preferably 0°-15°, and more preferred 6°-10°;
the edge angle of the longitudinal edge is between 6° and 25°, preferably between 10° and 20°,
the thickness of the blade is between 0.2 and 1 mm, preferably 0.25-0.80 mm, most preferred 0.35-0.60 mm;
the tooth backs in said tooth gaps are to a substantial part essentially flat, and first teeth and second teeth are unset and unswaged;
the blade is manufactured of a steel with a carbon content of 0.7-0.8%.

### DESCRIPTION OF DRAWINGS The invention will below be described more in detail with reference to the enclosed drawings, of which:

FIGS. 1 and 2 show two different types of known bread-knife blades, i.e. manufactured according to the known, comparatively expensive manufacturing method described above;

FIG. 3 shows a side view of a bread-knife blade according to a preferred embodiment of the invention with an arrow showing the sawing direction;

FIG. 4 shows a detailed view of a part of a bread-knife blade of the invention, according to the preferred embodiment, seen from the side; and

FIG. 5 shows a cross-sectional view of a bread-knife blade according to FIG. 4 along the line V-V.

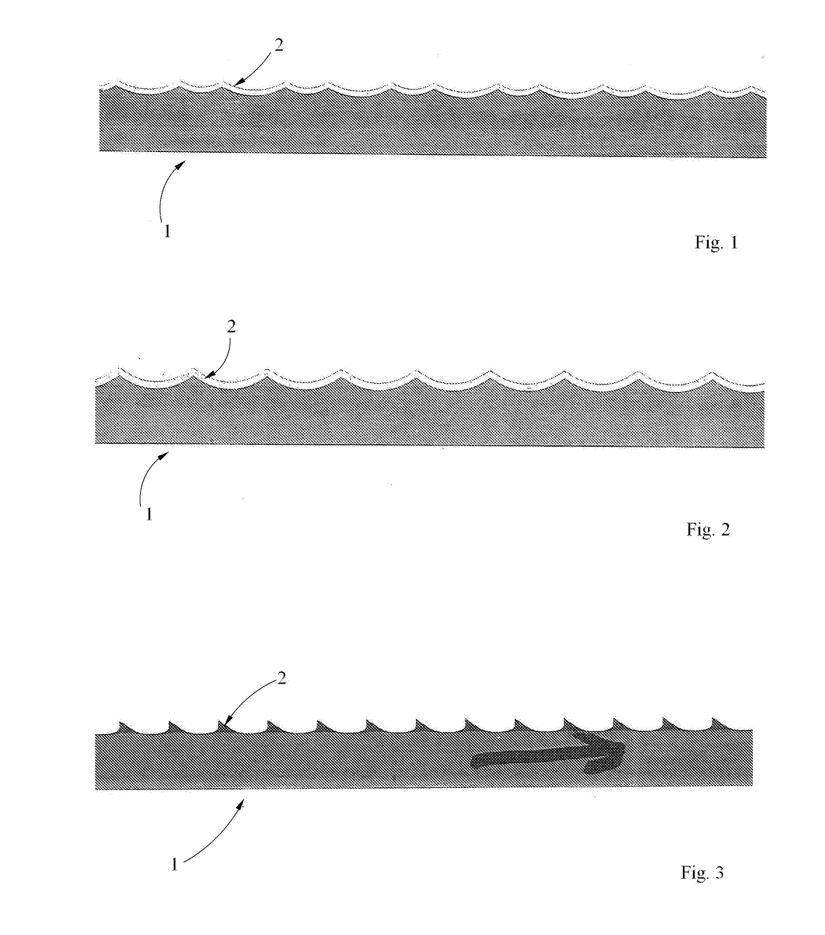

### DETAILED DESCRIPTION

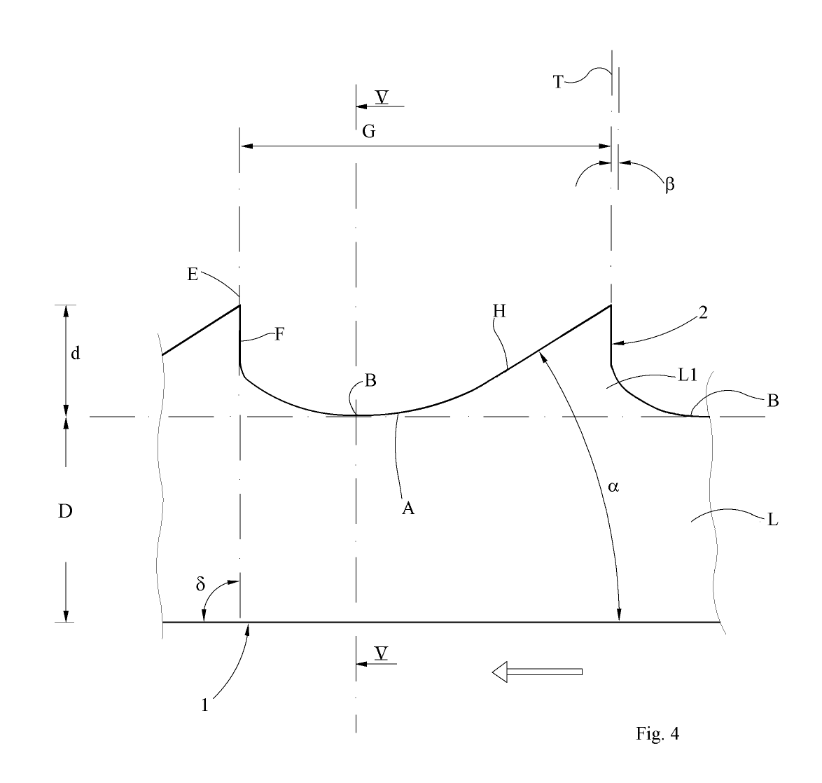

In FIGS. 3 to 5, a preferred embodiment of a bread-knife blade according to the invention is shown. The bread-knife blade is intended for use in a machine saw and has a given direction of motion, which is shown with an arrow in FIG. 3. The bread-knife blade has teeth 2 with a tooth edge E. At the front of each tooth 2 there is a tooth breast H, and behind the tooth edge E there is a tooth back F. A tooth bottom B extends between the tooth breast H and the tooth back F. The distance between two tooth edges

E constitutes a tooth gap G. The knife blade 1 has two flat sides, which, when the knife blade is regarded obliquely from above in the sawing direction, is defined as a right side R and a left side L.

A characteristic aspect of the invention in relation to known bread-knife blades is the asymmetric extension of the tooth breast H and the tooth back F i relation to a transverse line T. (Known blades normally have symmetry.) According to the invention, the asymmetry is such that the tooth breast H has an inclination a which is more acute in relation to the line of the blade in the longitudinal direction than the corresponding angle δ (90-β) which the tooth back F has in relation to the line in the longitudinal direction, i.e. the tooth back F inclines essentially steeper downwards than the tooth breast H.

Along its entire length, the bread-knife blade has on each side of the tooth edge E inclined grinding surfaces L1 and R1, respectively. Each of these grinding surfaces L1, R1 extends i different planes, which in relation to each other form an acute angle 2γ, implying that each of the surfaces L1, R1 forms an angle γ in relation to the central plane C of the bread-knife blade 1. The grinding surfaces L1, R1 extend from the tooth edge E down to the vicinity of the tooth bottom B, in such a way that the tooth bottom B at least partly has a flat, non-edge-forming surface B1.

The tooth gaps G of a bread-knife blade 1 according to the invention are in the range of 2-13 mm, preferably 3-8 mm. The tooth height d is in the range 1-4 mm, more preferred 2-3 mm. The height D of the unground part of the blade is essentially larger than the tooth height d, preferably 1-5 times larger than the tooth height d. The inclination a of the tooth breasts is normally in the range 10°-49°, preferably between 25° and 35° in relation to the longitudinal direction of the blade. According to the preferred embodiment, an essential part of the tooth breast H is flat, i.e. linear, while the tooth bottom B preferably has a concave curve. The tooth back F extends in an angel β in relation to a transverse line T, (which is orthogonal in relation to the longitudinal direction of the blade), which angle β is in the range −20° to 20°, preferably 0°-15°, and more preferred in the range 6°-10°.

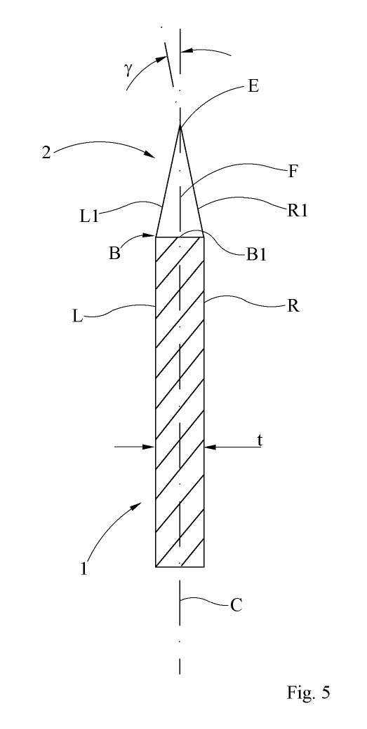

In FIG. 5, the blade is shown in cross-section. The blade 1 has a thickness, which is between 0.2 and 1 mm, preferably 0.25-0.80 mm, most preferred 0.35-0.60 mm. The grinding surfaces L1, R1 extend i different planes which each forms an angle γ with the central plane C, which angle y is in the range 6°-25°, preferably 10°-20°. The blade is manufactured of a steel with a carbon content of 0.7-0.8%.

Tests have proved that the blade has very good cutting properties. Somewhat surprisingly, users taking part in the tests have found that the blade makes essentially lower sound than conventional blades. In addition, which is probably a result of the fact that the blade moves very stably at cutting, it has proved that an extremely low wear occurs, i.e. that the blade lasts longer than traditional blades.

At the manufacture of a bread-knife blade 1 according to the invention a very cost-efficient manufacturing process may be used. According to this manufacturing process a bundle of a plurality carbon steel blades is arranged in parallel in a grinding machine. Depending on the capacity of the grinding machine (according to the invention, a bundle thickness of 30-100 mm, usually 40-50 mm may be handled) and the thickness t of the bread-knife blade 1, between 20 and 200 blades may be ground at a time in one bundle, preferably at least 50 blades. In the grinding machine a ceramic cutting edge is used, which cuts a plurality of tooth gaps G at a time in said bundle. Tests have proved that grinding discs with an effective grinding width of between 80 and 150 mm may advantageously be used. After each grinding, a successive moving forward takes place and a new set of tooth gaps are ground. Thereafter the bread-knife blades are one by one placed in a second grinding machine, which is provided with at least two grinding wheels which grind the inclined grinding surfaces L1 and R1. The feeding speed at the grinding of the side surfaces L1, R1 may be kept very high, normally at least 3 m per minute, but in certain cases up to 15 m per minute, implying a very effective production.

The invention is not limited to the above description but may be varied within the scope of the following claims. An obvious modification, which is within the frames of the invention, is that the grinding surfaces R1, L1 may, of course, be ground with curved grinding surfaces, but the use of flat grinding surfaces is often to prefer. Another obvious modification is that the extension of the tooth breast H may be curved, entirely or partly, and still achieve essential advantages in accordance with the basic concept of the invention. An advantage from a material point of view is that many different kinds of steel grades may be used for practising the invention. An example of a good steel grade is UHP15, with a carbon content of 0.75%. Further, it is realized that the knife blade 1 may be used for cutting of other materials than bread with similar properties as bread. It shall be realized that the expressions first and second grinding machine imply that the different grinding operations may, of course, be automatized to take place in the machine equipment with the same base frame but that also in such a case it shall be regarded as two different grinding machines even if they are arranged in one and the same machine frame.

1. A bread-knife blade for a machine saw, which bread-knife blade (1) has teeth (2) with a tooth edge (E), a tooth breast (H) at the front of the tooth, seen in the sawing directing, a tooth back (F) behind the tooth edge (E), and a tooth bottom (B) between the tooth breast on each tooth and the tooth back of next tooth in front thereof, and tooth gaps, wherein a tooth gap (G) is defined as the space between the tooth edges (E) of two subsequent teeth (2), which knife blade has two flat sides (L, R), a right side (R) and a left side (L), when the knife blade is regarded obliquely from above in the sawing directing, wherein said tooth edge (E) consists of a point, characterized in that
the knife blade, along the length of the knife blade on each side of said tooth edge (E), has inclined grinding surfaces (L1, R1), which grinding surfaces (L1, R1) each extends in different planes, which planes in relation to each other form an acute angle (2γ), implying that each one of the grinding surfaces (L1, R1) forms an acute angle (γ) in relation to the centre plane (C) of the bread-knife blade (1),
said grinding surfaces (L1, R1) extend from the tooth edge (E) down to the vicinity of said tooth bottom (B) arranged in such a way that the tooth bottom (B) at least partly has a flat non-edge-forming surface.

2. A bread-knife blade according to claim 1, characterized in that said tooth breast (H) and tooth back (F) are arranged to extend asymmetrically in relation to a common transverse line (T), wherein the tooth breast (H) has an inclination (α) which is more acute in relation to the line of the longitudinal direction of the blade than the corresponding angle (δ), which the tooth back (F) has in relation to the line of the longitudinal direction.

3. A bread-knife blade according to claim 1, characterized in that said tooth breast (H) has an angle (α) in relation to the longitudinal direction of the blade in the range 10°-9°, preferably between 25° and 35°.

4. A bread-knife blade according to claim 3, characterized in that the tooth breasts (H) to a substantial part are essentially linear.

5. A bread-knife blade according to claim 4, characterized in that the angle (β) between a transverse line (T) and a line between the tooth edge (E) and the centre point of the tooth back (F) is in the range −20°to +20°, preferably 0°-15°, more preferred 6°-10°.

6. A bread-knife blade according to claim 5, characterized in that the edge angle (γ) of the longitudinal edge is between 6° and 25°, preferably between 10° and 20°.

7. A bread-knife blade according to claim 6, characterized in that said different planes, in which the grinding surfaces (L1, R1) extend, are non-curved grinding planes.

8. A bread-knife blade according to claim 7, characterized in that the thickness (t) of the blade is between 0.2 and 1 mm, preferably 0.25-0.80 mm, most preferred 0.35-0.60 mm.

9. A bread-knife blade according to claim 1, characterized in that said first and second teeth (2) are unset and unswaged.

10. A bread-knife blade according to claim 8, characterized in that the blade (1) is manufactured of a steel with a carbon content of 0.7-0.8%.

11. A bread-knife blade according to claim 10, characterized in that said tooth gaps (G) have a distance of 2-13 mm, preferably 3-8 mm.

12. A method to manufacture a bread-knife blade (1) according to claim 1, characterized in the following manufacturing steps:
a) arrangement of a bundle of a plurality of carbon steel blades (1) in parallel in a first grinding machine;
b) cutting of a plurality of tooth gaps (G) at a time in said bundle;
c) provision of an edge (E) in a blade (1) at a time by means of a longitudinal surface grinding on each side of said tooth gaps (G) in a second grinding machine.

13. A method according to claim 12, characterized in that in step a) at least 20 blades (1) are arranged at a time in a bundle.

14. A method according to claim 13, characterized in that in step b) at least 4 subsequent tooth gaps (G) are cut at a time for each blade.

15. A method according to claim 14, characterized in that the feeding speed in step c) is at least 3 m/min.
